(19) United States
(12) Patent Application Publication
(10) Pub. No.: US 2008/0033955 A1
(43) Pub. Date: Feb. 7, 2008

(54) Data management system, and access authorization setting method, and computer product

(75) Inventor: Yusaku Fujii, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/634,660

(22) Filed: Dec. 6, 2006

(30) Foreign Application Priority Data
Aug. 7, 2006 (JP) 2006-214840

(51) Int. Cl. G06F 17/30

(52) U.S. Cl. 707/9

(57) ABSTRACT

A mail server receives and analyzes email, and extracts an identifier. The mail server sends the identifier and address information related to the email to a management server. The management server sets access authorization to data specified by the identifier to allow a user corresponding to the address information to access the data. In the process of sequentially forwarding email to notify the availability of the data to interested users, access authorization is set automatically for those users.

### BACKGROUND OF THE INVENTION

1. Field of the Invention

The present invention relates to a technology for automatically setting access right to data stored in a server.

2. Description of the Related Art

In parallel with the progress in information processing, increasingly vast amounts of electronic documents are being produced each day in a typical large organization. Usually these documents are kept in a file server and access to these documents is given to relatively few users. However, enterprise content management (ECM), which is a centralized system for managing vast amounts of documents, has emerged in recent years with an object to putting the documents to effective use to the maximum possible extent.

Such centralized document management systems should allow free access to authorized users and deny access to unauthorized users. However, as large volumes of documents are managed in such systems, access authorizations of users will have to be set manually for every document, making it virtually impractical.

Japanese Patent Application Laid-open No. 2005-346492 discloses a technology wherein access authorization to shared contents is set automatically. In this technology, a second shared contents is derived from a first shared contents, and-access authorization to the second shared contents is automatically set based on an access history of the first shared contents.

Japanese Patent Application Laid-open No. 2005-346492 also discloses a technology wherein-access authorization to the second shared contents is automatically set based on recipient addresses to which a creator of the second shared contents sends email introducing the second shared contents.

However, the technology described above can automatically set access authorization only to users who have previously used the existing contents and to the recipients of the email sent by the creator of the contents. In other words, access authorization cannot be automatically set for documents (contents) created for a completely new purpose and for which even the contents creator has no clear idea who might be interested in the documents.

### SUMMARY OF THE INVENTION

It is an object of the present invention to at least partially solve the problems in the conventional technology.

According to an aspect of the present invention, a data management system includes a management server that sets access right to each data stored thereon to restrict access to the data, and an information server that delivers information. The information server includes an analyzing unit that receives and analyzes information to check whether the information contains an identifier that indicates a location of data stored on the management server, and, when an identifier exists, extracts the identifier from the information, and a requesting unit that sends the identifier, an information source address and an information destination address to the management server specified by the identifier as a request to set access right to the data. The management server includes a converting unit that refers to a conversion table to convert the information source address and the information destination address to identification information for access control on the management server, and an access-right setting unit that sets access right to the data specified by the identifier to allow a user with the identification information to access the data.

According to another aspect of the present invention, a data management system includes a management server that sets access right to each data stored thereon to restrict access to the data, and a terminal device that accesses the data stored on the management server. The terminal device includes an identifier reading unit that receives distributed data and reads from the distributed data an identifier that indicates a location of data stored on the management server, and a requesting unit that sends the identifier and identification information of a user of the terminal device to the management server specified by the identifier as a request to set access right to the data. The management server includes an access-right setting unit that sets access right to the data specified by the identifier to allow a user with the identification information to access the data.

According to still another aspect of the present invention, a data management system includes a management server that sets access right to each data stored thereon to restrict access to the data, and an information server that delivers information. The information server includes an analyzing unit that receives and analyzes information to check whether the information is accompanied by data, and, when data exists, computes a message digest for the data, and a requesting unit that sends the message digest, an information source address and an information destination address to at least one predetermined management server as a request to set access right to the data. The management server includes a storing unit that computes a message digest for data to store the data in the management server in association with the message digest, a converting unit that refers to, upon receiving the request, a conversion table to convert the information source address and the information destination address to identification information for access control on the management server, and an access-right setting unit that sets access right to data associated with a message digest that matches the message digest from the information server to allow a user with the identification information to access the data.

According to still another aspect of the present invention, an access-right setting method that is applied to a data management system that includes a management server to set access right to each data stored thereon to restrict access to the data and an information server to deliver information, includes the information server receiving and analyzing information to check whether the information contains an identifier that indicates a location of data stored on the management server, the information server extracting the identifier from the information, the information server sending the identifier, an information source address and an information destination address to the management server specified by the identifier as a request to set access right to the data, the management server referring to a conversion table to convert the information source address and the information destination address to identification information for access control thereto, and the management server setting access right to the data specified by the identifier to allow a user with the identification information to access the data.

According to still another aspect of the present invention, an access-right setting method that is applied to a data management system that includes a management server to set access right to each data stored thereon to restrict access to the data and a terminal device that accesses the data stored on the management server, includes the terminal device receiving distributed data and reading from the distributed data an identifier that indicates a location of data stored on the management server, the terminal device sending the identifier and identification information of a user thereof to the management server specified by the identifier as a request to set access right to the data, and the management server setting access right to the data specified by the identifier to allow the user with the identification information to access the data.

According to still another aspect of the present invention, an access-right setting method that is applied to a data management system that includes a management server to set access right to each data stored thereon to restrict access to the data and an information server to deliver information, includes the management server computing a first message digest for data to store the data in association with the first message digest, the information server receiving and analyzing information to check whether the information is accompanied by data, the information server computing a second message digest for the data, the information server sending the second message digest, an information-source address and an information destination address to at least one predetermined management server as a request to set access right to the data, the management server referring to, upon receiving the request, a conversion table to convert the information source address and the information destination address to identification information for access control thereto, and the management server setting access right to the data associated with the first message digest that matches the second message digest to allow a user with the identification information to access the data.

According to still another aspect of the present invention, a computer-readable recording medium stores therein a computer program that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of an example of an environment to which an access authorization setting method according to a first embodiment of the present invention is applied;

FIG. 2 is a schematic for explaining an overview of the access authorization setting method;

FIG. 3 is a functional block diagram of a management server shown in FIG. 1;

FIG. 4 is an example of contents of an access-authorization control table;

FIG. 5 is an example of contents of an address conversion table;

FIG. 6 is a functional block diagram of a mail server shown in FIG. 1;

FIG. 7 is a flowchart of the operation of the management server for document registration;

FIG. 8 is a flowchart of the operation of the mail server upon receiving email;

FIG. 9 is a-flowchart of the operation of the management server for access-authorization setting;

FIG. 10 is a functional block diagram of a computer that executes a data management program;

FIG. 11 is a schematic of an example of an environment to which an access authorization setting method according to a second embodiment of the present invention is applied;

FIG. 12 is a schematic for explaining an overview of the access authorization setting method;

FIG. 13 is a functional block diagram of a management server shown in FIG. 11;

FIG. 14 is an example of contents of an access-authorization control table;

FIG. 15 is a functional block diagram of a terminal device shown in FIG. 11;

FIG. 16 is a flowchart of the operation of the management server for document registration;

FIG. 17 is a flowchart of the operation of the terminal device to access document data; and

FIG. 18 is a flowchart of the operation of the management server for access-authorization setting.

### DETAILED DESCRIPTION OF THE PREFERRED EMBODIMENTS

Exemplary embodiments of the present invention are described below with reference to the accompanying drawings.

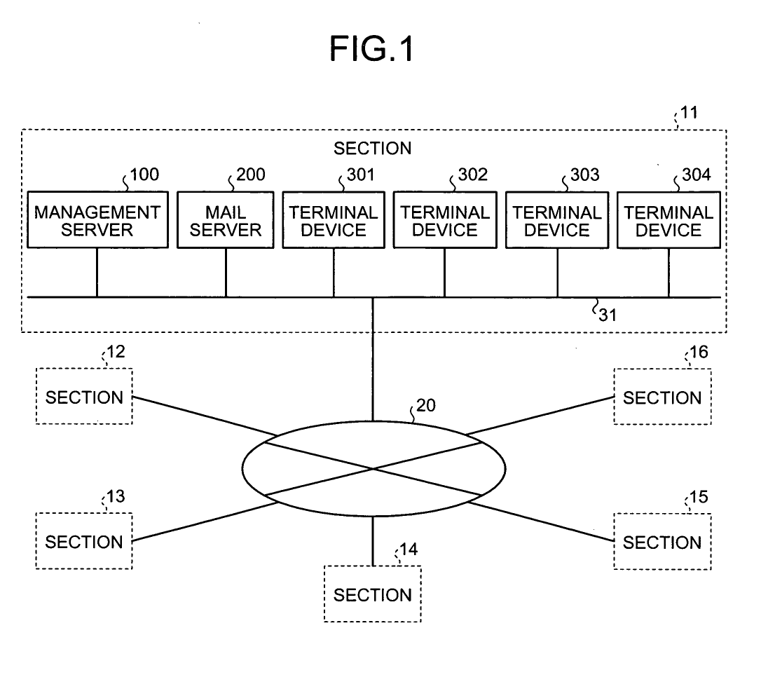

FIG. 1 is a schematic of an example of an environment to which an access authorization setting method according to a first embodiment of the present invention is applied.

Shown in FIG. 1 is an intranet that includes a network 20 that connects sections 11 to 16. The section 11 includes a management server 100, a mail server 200, and terminal devices 301 to 304 used by users to create or view documents, all of which are connected to a local area network (LAN) 31. The sections 12 to 16 also have the same structure as the section 11.

The management server 100 has the capacity to store large volumes of data such as documents. Apart from the terminal devices 301 to 304 in the section 11, the documents stored on the management server 100 can also be accessed by the terminal devices in the sections 12 to 16. However, the management server 100 is configured to manage documents properly by setting access authorization to every document by specifying users that can access the document. In other words, the users for whom authorization for accessing a given document is not set cannot access the document.

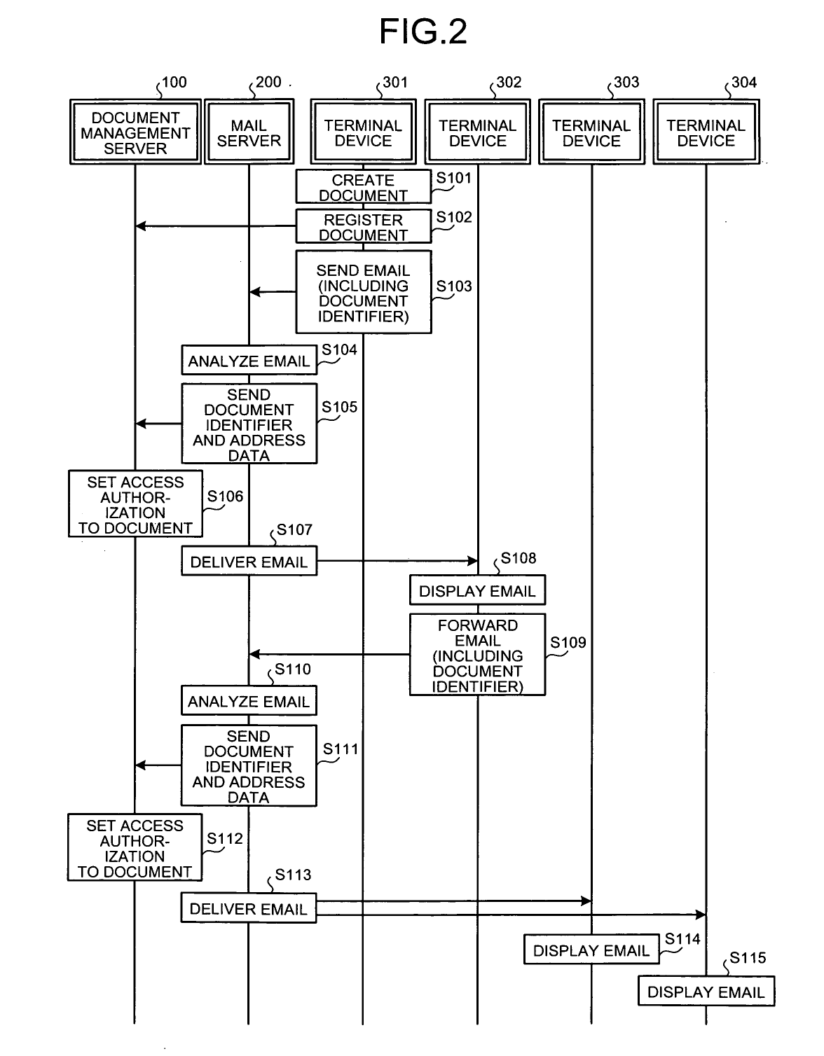

FIG. 2 is a schematic for explaining an overview of the access authorization setting method. The document supposed in the description is a document created by the user of the terminal device 301.

Once the user of the terminal device 301 has created the document (step S101), the user stores the document on the management server 100 to share the document with other users (step S102). While storing the document on the management server 100, the user sets access authorization to the document so that only the user himself/herself can access it, thus disabling accidental unauthorized access.

The user of the terminal device 301 notifies via email the user requiring the document created by self that the document is shared (step S103). It is supposed in this example that the user of the terminal device 301 is aware that the user of the terminal device 302 needs the document created by self, but is not aware whether the other users need the document, and therefore sends the email to the user of the terminal device 302.

The user of the terminal device 301 includes in the email a character string (hereinafter, “document identifier”) of a predetermined format, indicating a, location of the document on the management server 100. The document identifier, for example, can be in the form of a uniform resource locator (URL) or universal naming convention (UNC).

The email sent from the terminal device 301 is received by the mail server 200. The mail server 200 analyzes the email and checks whether the email contains a document identifier (step S104). If the email contains a document identifier, the mail server 200 sends the document identifier and the recipient email address to the management server 100, requesting the management server 100 to set the access authorization to the document indicated by the document identifier (step S105).

Upon receiving the request, the management server 100 identifies the document corresponding to the document identifier and sets the access authorization to the document so that the user corresponding to the recipient email address can access the document (step S106). Specifically, the management server 100 sets the access authorization so that the user of the terminal device 302 can access the document.

After the access authorization is set, upon request made from the terminal device 302, the email sent from the terminal device 301 is delivered to the terminal device 302 from the mail server 20.0 (step S107). The email, displayed on a display device of the terminal device 302, can be viewed by the user of the terminal device 302 (step S108). As the content in the email carries the access authorization, authorizing the user of the terminal device 302 to access the document, the document is all ready to be viewed by the user of the terminal device 302 at this step.

Once the content of the email has been checked, the user of the terminal device 302 forwards the email received from the user of the terminal device 301 to other users to convey the fact that the document mentioned in the email is now shared (step S109). It is supposed in this example that the user of the terminal device 302 is aware that the users of the terminal devices 303 and 304 can make use of the document (step S109). Hence, in this case, the user of the terminal device 302 forwards the email to the users of the terminal devices 303 and 304. The document identifier is retained unchanged in forwarded email to indicate the location of the document.

The term “forwarding” in the present description includes, apart from forwarding a received email unchanged, forwarding email to a third party by suitably editing the text content of the main body of the email while retaining the document identifier of the original email.

The email sent from the terminal device 302 is received by the mail server 200. The mail server 200 analyzes the email and checks whether the email contains a document identifier (step S110). If the email contains a document identifier, the mail server 200 sends the document identifier and the recipient email address to the management server 100, requesting the management server 100 to set the access authorization to the document indicated by the document identifier (step S111).

Upon receiving the request, the management server 100 identifies the document corresponding to the document identifier and set the access authorization to the document so that the user(s) corresponding to the recipient email address(es) can access the document (step S112). Specifically, the management server 100 sets the access authorization so that the users of the terminal devices 303 and 304 can access the document.

After the access authorization is set, upon request made from the terminal devices 303 and 304, the email sent from the terminal device 302 is delivered to the terminal devices 303 and 304 from the mail server 200 (step S113). The email, displayed on display devices of the terminal devices 303 and 304, can be viewed by the users of the terminal devices 303 and 304, respectively (step S115).

As the content of the email carries the access authorization, authorizing the users of the terminal devices 303 and 304 to access the document, the document is all ready to be viewed by the users of the terminal devices 303 and 304 at this step.

Once the content of the email has been checked, the users of the terminal devices 303 and 304 can, if required, forward the email received from the user of the terminal device 302 to other users to convey that the document mentioned in the email is now shared. The email can be forwarded to not just to the users in the section 11, but to the users in other sections as well.

The mail server 200 or, in case the email is forwarded to another section, a server of the concerned section that has the same function as the mail server 200 (hereinafter, “the mail server 200, etc.” receives the forwarded email. The mail server 200, etc. checks whether the email contains a document identifier, and if so, sets the access authorization for the user corresponding to the recipient email address included in the email, authorizing the user to access the document corresponding to the document identifier.

Thus, in the access authorization setting method according to the first embodiment, the document creator sends email containing therein a document identifier to an interested user, and the mere act of sending the email containing the document identifier automatically authorizes the recipient of the email to access the document. The recipient may use his/her discretion and forward the email containing therein the document identifier to other users, thus allowing more access authorizations to be set automatically. Thus, access authorization to access any document is automatically set for interested users the document creator may not even be aware of.

In the access authorization setting method according to the first embodiment, access authorization is automatically set by performing a commonly practiced act of sending email including therein a URL, or the like, indicating the location of the document.

To prevent access authorizations from being set in an uncontrolled manner, the access authorization setting method according to the first embodiment has a control imposed on setting access authorizations based on the time that has elapsed since a document is stored on the management server 100, the position of the email sender, etc.

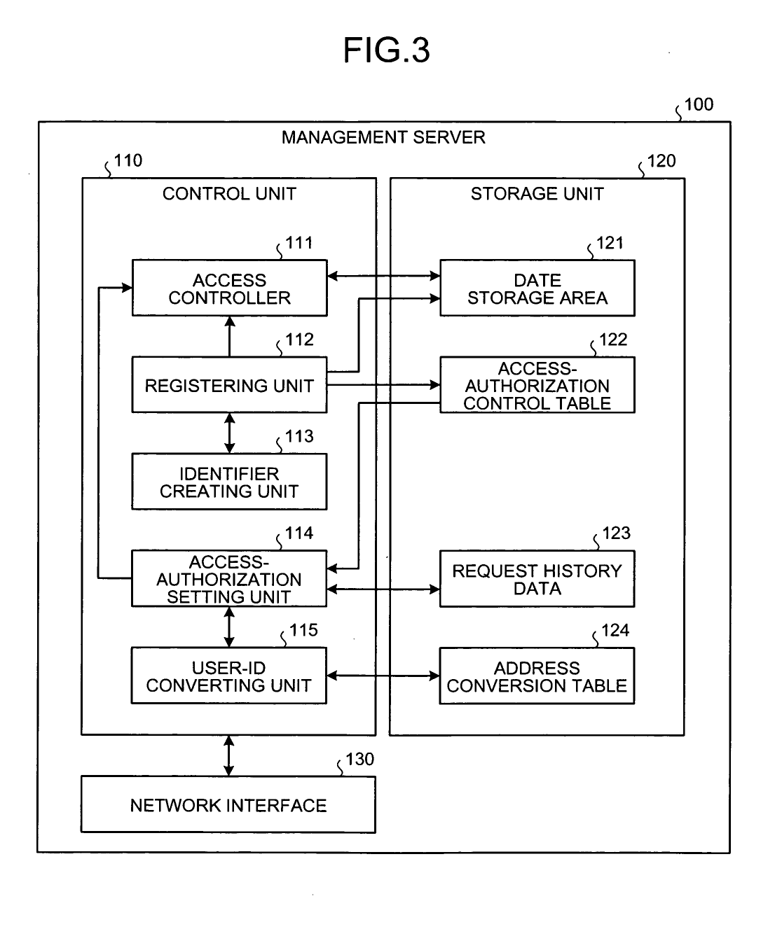

FIG. 3 is a functional block diagram of the management server 100. The management server 100 includes a control unit 110, a storage unit 120, and a network interface 130. The network interface 130 functions as an interface by which the management server 100 sends and receives data over a network.

The control unit 110 controls the entire management server 100, and includes an access controller 111, a registering unit 112, an identifier creating unit 113, an access-authorization setting unit 114, and a user-ID converting unit 115. The access controller 111 set an access authorization to every document stored in a data storage area 121 of the storage unit 120, and performs various control actions so that only users having access authorization can access any document.

The registering unit 112 stores the document in the data storage area 121 according to the specification from the user, and requests the access controller 111 to set the specified access authorization to the document. When storing the document in the data storage area 121, the registering unit 112 sets, according to the specification from the user, information pertaining to the control of automatic setting of the access authorization in an access-authorization control table 122 of the storage unit 120.

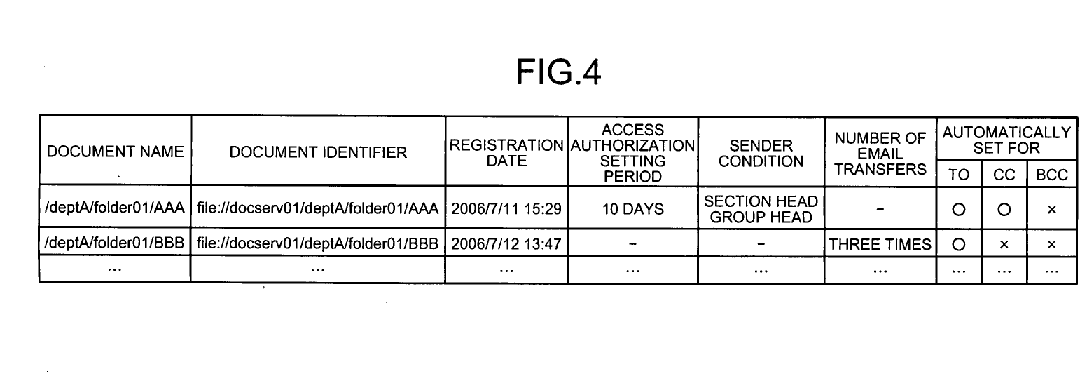

FIG. 4 is an example of contents of the access-authorization control table 122. The access-authorization control table 122 includes fields: Document name, Document identifier, Registration date, Access-authorization setting period, Sender condition, Number of email transfers, and Automatically set for, and contains entries for all the documents stored in the data storage area 121.

The Document name field contains path names by which the management server 100 internally identifies the documents stored in the data storage area 121. The Document identifier field contains character strings of a predetermined format that indicate the storage location of the document from the perspective of the management server 100 and other devices connected to the network. In the example shown in FIG. 4, the storage locations of the documents are shown as character strings indicating URLs. The Registration date field contains the dates on which the documents are stored.

The fields Access-authorization setting period, Sender position, No. of forwards, and Recipients contain information pertaining to the control of automatic setting of the access authorization and can be set according to the discretion of the document creator at the time of storing the document.

The Access-authorization setting period field specifies the period from the registration date for which automatic access authorization setting is enabled. This field is provided taking into account the tendency that the email containing the document identifier is sent to interested users only within a specific period, beyond which there is a likelihood of the email being forwarded indiscriminately. Thus, by setting an appropriate period in Access authorization setting period field, the access authorization to the document can be limited only to interested users. When no temporal constraint for automatic setting of access authorization is required, the Access-authorization setting period field is left blank.

The Sender condition field contains the sender's email address or the group name of the group to which the sender belongs, and automatic access authorization takes place only if the email is received from the sender specified in the Sender condition field. Setting this field ensures that access authorization is automatically granted only upon receipt of formal email, for example, from a section chief. When no limitation is imposed on the sender for automatic setting of access authorization, the Sender condition field is left blank.

Number of email transfers field contains a value that specifies the number of times the email can be forwarded after it is received from the original sender to determine whether to allow automatic setting of access authorization. This field is provided taking into account the tendency that that the email containing the document identifier is sent to interested users only in a relatively small number for forwards, beyond which there is a likelihood of the email being forwarded indiscriminately. Thus, by setting an appropriate value in Number of email transfers field, the access authorization to the document can be limited only to interested users. When no constraint is required on the number of forwards for automatic setting of access authorization, the Number of email transfers field is left blank.

The Automatically set for field contains specification of the type of email addresses contained in the information sent from the mail server 200, etc. for which access authorization is to be set automatically. Specifically, the Automatically set for field specifies whether access authorization is to be set automatically for the email address specified in one or more of To, CC, or BCC fields.

Apart from setting whether access authorization is to be set automatically, the access level can also be set for each type of email address. It is common practice to put the email address of the user directly concerned with the subject in To field, and those that are not directly concerned in CC field or BCC field. Thus, it is possible to automatically set the access level to enable the user specified in the To field to edit the document and those specified in the CC or BCC field to only read the document, thus enabling automatic setting of access level along with access authorization according to degree of relevance of the user.

The entry in the first row of FIG. 4 shows that a document having the name /deptA/folder01/AAA and identified by a document identifier file://docserv01/deptA/folder01/AAA by other devices on the network is registered in the data storage area 121 of the management server 100 on Jul. 11, 2006 at 15:29 hours.

The entry in the first row of FIG. 4 further shows that if email containing the document identifier file://docserv01/deptA/folder01/AAA is sent or forwarded by either the Section head or a user belonging to a group called Group head within 10 days of the registration date of the specified document, access authorization is automatically set for the users specified in the To and CC fields of the email.

The entry in the second row of FIG. 4 shows that a document having the name /deptA/folder01/BBB and identified by a document identifier file://docserv01/deptA/folder01/BBB by other devices on the network is registered in the data storage area 121 of the management server 100 on Dec. 7, 2006 at 13:47 hours.

The entry in the second row of FIG. 4 further shows that if the number of forwards of the email containing the document identifier file://docserv01/deptA/folder01/BBB is three or less with the sending of the original email as the starting point, access authorization is automatically set for the users specified in the To field of the email.

The identifier creating unit 113 creates, according to a request from the registering unit 112, a document identifier for the document stored in the data storage area 121 by the registering unit 112.

The access-authorization setting unit 114 sets access authorization to the document stored in the data storage area 121 based on the information received from the mail server 200, etc. Upon receiving a request from the mail server 200, etc., the access-authorization setting unit 114 looks up and retrieves from the access-authorization control table 122-the entry having the document identifier included-in the request.

If no entry having the document identifier included in the request is found in the access-authorization control table 122, the access-authorization setting unit 114 ends the process without setting the access authorization.

If an entry is found in the access-authorization control table 122 that has the document identifier included in the request, the access-authorization setting unit 114 checks whether any value is set in the Access-authorization setting period field, and if so, calculates the time limit for automatic access authorization setting by adding the value to the registration date in the entry. If the current date is beyond the calculated time limit, the access-authorization setting unit 114 ends the process without setting the access authorization.

If a value is set in the Sender condition field of the entry, the access-authorization setting unit 114 the sender's email address included in the information received from the mail server 200, etc. If the sender's email address does not match with any of the addresses and does not belong to the group set in the Sender condition field, the access-authorization setting unit 114 ends the process without setting the access authorization.

The access-authorization setting unit 114 determines the group to which the email address belongs by referring to an address conversion table 124 stored in the storage unit 120.

If a value is set in the Number of email transfers field, the access-authorization setting unit 114 refers to a request history data 123 stored in the storage unit 120 and determines how many times the email in question has been sent/forwarded, taking the sending of the original email as the starting point. The request history data 123 has recorded therein, in the form of history, data pertaining to the emails sent from the mail server 200. The number of forwards can be determined by extracting the entries in the request history data 123 having the same document identifier as the one received in the current email and establishing the sender-receiver relation. If the determined value is beyond the value set in the Number of email transfers field, the access-authorization setting unit 114 ends the process without setting the access authorization.

If none of the constraints described above are contradicted in the information sent from the mail server 200, etc., the access-authorization setting unit 114 extracts the receiver's email address set in the email address type field set in the Automatically set for field of the retrieved entry, passes on the extracted receiver's email address to the user-ID converting unit 115, which converts the receiver's email address to the user ID the management server 100 needs for performing access control. The access controller 111 then sets the access authorization to the document corresponding to the document identifier included in the information received from the mail server 200, etc., so that the user having the extracted user ID can access the document.

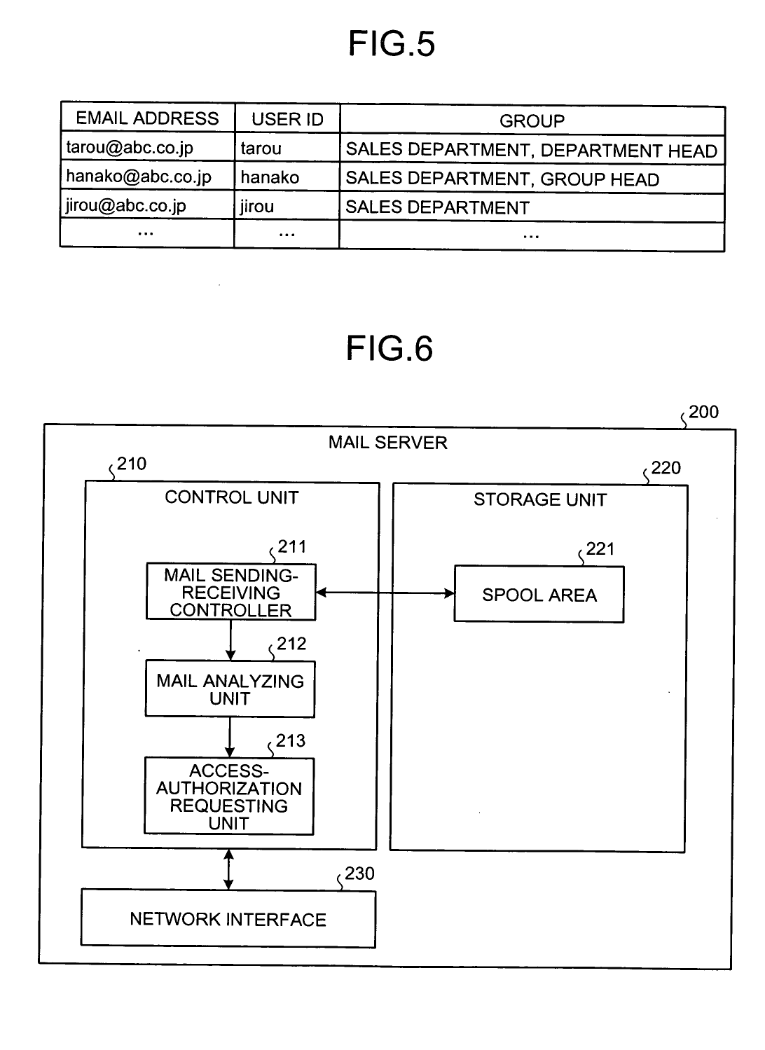

The user-ID converting unit 115 acts upon the instruction from the access-authorization setting unit 114 and converts the email address to the user ID by referring to the address conversion table 124. FIG. 5 is an example of contents of the address conversion table 124. The address conversion table 124 includes the fields Email address, User ID, and Affiliated group.

The Email address field contains the email addresses that are to be converted to user ID. The User ID field contains the user IDs corresponding to the email addresses. The field Affiliated group contains the names of the groups to which the email addresses belong. The groups may be categorized by designation or by department.

The storage unit 120 stores therein various types of data and includes the data storage area 121, and stores therein the access-authorization control table 122, the request history data 123, and the address conversion table 124. The access-authorization control table 122, the request history data 123, and the address conversion table 124 have already been described.

FIG. 6 is a functional block diagram of the mail server 200. The mail server 200 includes a control unit 210, a storage unit 220, and a network interface 230. The network interface 230 functions as an interface by which the mail server 200 sends and receives data over the network.

The control unit 210 controls the entire mail server and includes a mail sending-receiving controller 211, a mail analyzing unit 212, and an access-authorization requesting unit 213. The mail sending-receiving controller 211 performs general control related to sending and receiving email according to a mail transfer protocol-such as Simple Mail Transfer Protocol (SMTP) or Post Office Protocol (POP).

The mail analyzing unit 212 analyzes the content of the email received by the mail sending-receiving controller 211 addressed to a user of the mail server 200 and if the email contains a document identifier, extracts it.

The access-authorization requesting unit 213 identifies the management server in which the document corresponding to the document identifier extracted by the mail analyzing unit 212 is stored. The access-authorization requesting unit 213 then sends to the management server the document identifier, and the sender's email address and the email addresses in the To, CC, and BCC fields included in the emails, and requests for access authorization.

The storage unit 220 stores various types of data and includes a spool area 221. The spool area 221 is where the mail sending-receiving controller 211 stores the email directed to and sent from the addresses of the users belonging to the mail server.

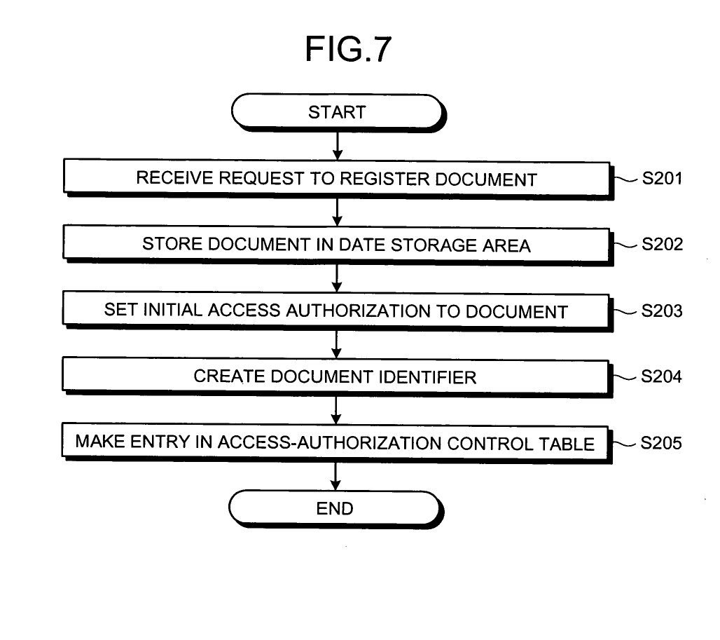

FIG. 7 is a flowchart of the operation of the management server 100 for document registration.

Upon receiving a request to register a document from a document creator via the terminal devices 301 to 304, the registering unit 112 receives the document (step S201). The access controller 111 stores the document in the data storage area 121. (step S202) and sets the specified initial access authorization (step S203).

The identifier creating unit 113 creates a document identifier for the document stored in the data storage area 121 (step S204). The newly created document identifier and the various constraint parameters specified by the document creator are set in the access-authorization control table 122, creating a new entry (step S205).

After storing the document on the management server 100, the document creator retrieves the document identifier from the access-authorization control table 122, includes the document identifier in email and sends the email to interested users to announce the availability of the document. Upon receiving the email, the users in turn may further forward the email to other interested users they might be aware of, and so on. The email sent by the document creator or forwarded by the users reach the mail server 200. The process procedure of the mail server 200 is described below.

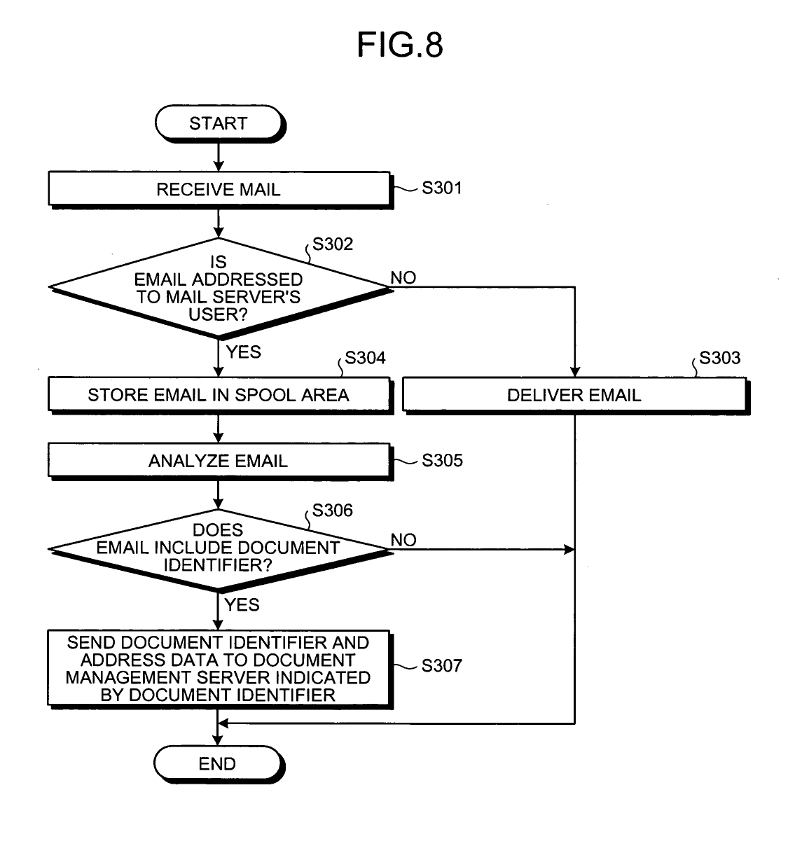

FIG. 8 is a flowchart of the operation of the mail server 200 upon receiving the email. Upon receiving the email (step S301), the mail sending-receiving controller 211 checks whether the email is addressed to the user of the mail server 200 (step S302). If the email is not addressed to the user of the mail server 200 (No at step S302), the mail sending-receiving controller 211 passes on the email to the appropriate destination and ends the process (step S303).

However, if the email is addressed to the user of the mail server 200 (Yes at step S302), the mail sending-receiving controller 211 stores the email in the spool area 221 (step S304). The mail analyzing unit 212 analyzes the content of the email (step S305), and if the email includes a document identifier (Yes at step S306), the access-authorization requesting unit 213 sends the document identifier and the address data to the management server 100 indicated by the document identifier and requests for an access authorization (step S307).

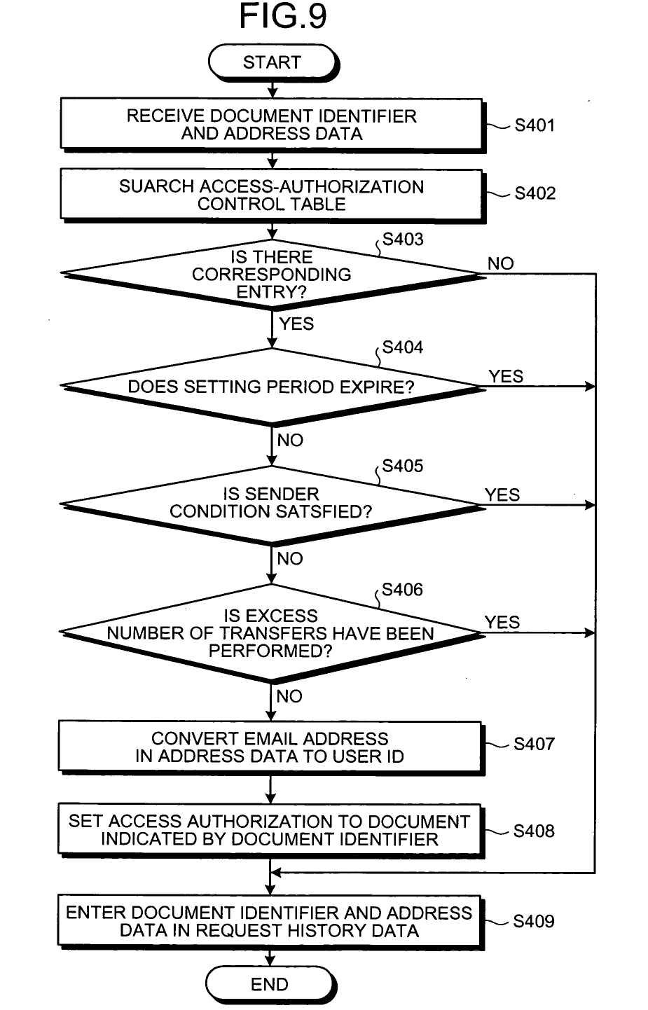

FIG. 9 is a flowchart of the operation of the management server 100 for access-authorization setting.

Upon receiving the document identifier and the address data from the mail server 200 (step S401), the access-authorization setting unit 114 retrieves the document identifier from the access-authorization control table 122 (step S402).

If no entry is found for the document identifier (No at step S403), the access-authorization setting unit 114 enters the document identifier and the address data in the request history data 123 and ends the process (step S409).

However, if an entry is found for the document identifier (Yes at step S403), the access-authorization setting unit 114 first checks whether a value is set in the Access-authorization setting period of the entry, and if a value is set, adds the value to the value set in the Registration date field and calculates the time limit for automatic access authorization setting. If the current date is beyond the calculated time limit (Yes at step S404), the access-authorization setting unit 114 enters the document identifier and the address data in the request history data 123 and ends the process (step S409).

Further, if a value is set in the Sender's constraint field of the entry, the access-authorization setting unit 114 retrieves the sender's email address sent from the mail server 200 and checks whether the sender's email address belongs to the group set in the Sender's constraint field. If the retrieved sender's email address does not belong to the group set in the Sender's constraint field (Yes at step S405), the access-authorization setting unit 114 enters the document identifier and the address data in the request history data 123 and ends the process (step S409).

If a value is set in the Number of email transfers field, the access-authorization setting unit 114 refers to the request history data 123 and determines how many times the email referred to in the request has been sent/forwarded, taking the sending of the original email as the starting point. If the determined value exceeds the value in the Number of email transfers field (Yes at step S406), the access-authorization setting unit 114 enters the document identifier and the address data in the request history data 123 and ends the process (step S409).

If none of the three conditions described above are contradicted (No at steps S404, S405, and S406), the access-authorization setting unit 114 extracts from the information received from the mail server 200 the destination email address(es) of the type(s) that is/are specified in the Automatic authorization for field of the entry, passes on the extracted destination email address(es) to the user-ID converting unit 115 to be converted to the user ID(s) required by the management server 100 to perform access control (step S407). The access controller 111 then sets access authorization to the document corresponding to the document identifier included in the information received from the mail server 200 so that the user(s) having the user ID(s) can access the document (step S408), and enters the document identifier and the address data in the request history data 123, ending the process (step S409).

Various modifications of the configuration of the management server 100 shown in FIG. 3 are possible, provided there is no departure from the essence of the present invention. For example, a program can be executed by a computer to perform the function of the control unit 110 of the management server 100. A computer executing a data management program 1071 that performs the function of the control unit 110 is described below.

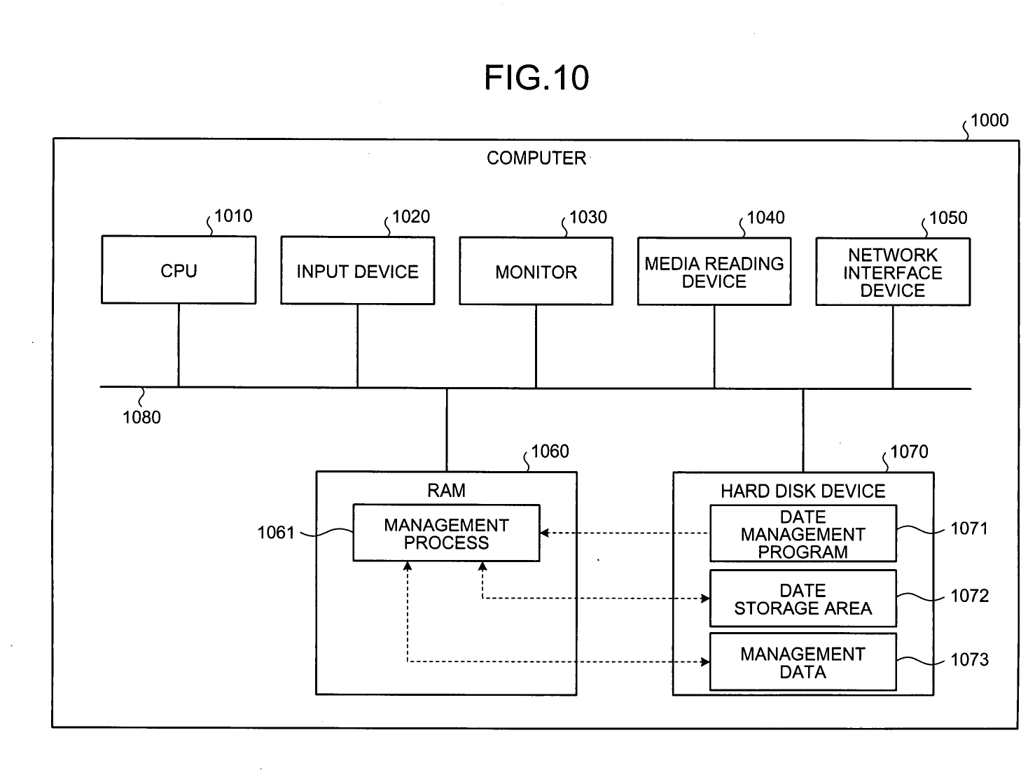

FIG. 10 is a functional block diagram of a computer 1000 that executes the data management program 1071. The computer 1000 includes a central processing unit (CPU) 1010 that performs various types of calculations, an input device 1020 that receives input of data from the user, a monitor 1030 that displays data, a media reading device 1040 that reads programs and the like from a recording medium, a network interface device 1050 through which data exchange between the computer 1000 and other computers take place over a network, a random access memory (RAM) 1060 that temporarily stores data, a hard disk device 1070, and a bus 1080 that connects all the above devices.

The hard disk device 1070 has stored therein the data management program 1071 that performs the function of the control unit 110 shown in FIG. 3. The hard disk device 1070 includes a data storage area 1072 similar to the data storage area 121 shown in FIG. 3. The data storage area 1072 has stored therein management data 1073 that corresponds to the access-authorization control table 122, the request history data 123, and the address conversion table 124.

Both the data storage area 1072 and the management data 1073 or either of them can be provided on another computer connected via the network.

A data management process 1061 is set in motion when the CPU 1010 loads the data management program 1071 onto the RAM 1060 from the hard disk device 1070. Data processing in the data management process 1061 takes place when the data in the data storage area 1072 and the management data 1073 are loaded onto the same area in the RAM 1060 to which the data management process 1061 is allocated.

Apart from the hard disk device 1070, the data management program 1071 can be stored in other storage mediums such as CD-ROM, from which the computer 1000 can read it. Alternatively, the data management program 1071 can be stored in another computer (or server) connected to the computer 1000 via a public circuit, Internet, local area network (LAN), wide area network (WAN), etc.

Similarly, various modifications of the configuration of the mail server 200 shown in FIG. 6 are possible, provided there is no departure from the essence of the present invention. For example, a computer-readable program can functionally replace the control unit 210 of the mail server 200. The computer that reads the program will have the same configuration as the computer 1000.

As described above, according to the first embodiment, when email containing a document identifier is received by the mail server, access authorization is automatically set for the receiver of the email to access the document on the management server corresponding to the document identifier. Thus, in the process of sequentially forwarding email to notify the availability of the document to interested users, access authorization can be set automatically for those users enabling them to access the document.

Moreover, a document identifier in the form of a URL, and the like is included in the email notifying the availability of a document, and the mail server recognizes the document identifier and requests the concerned management server for access authorization. Alternatively, the document itself can be attached to the email.

For attaching the document to the email, the registering unit 112 of the management server 100, when requested to register a document, uses a hash algorithm such as MD5 to calculate a message digest for the document, and stores in the access-authorization control table 122 the calculated message digest, associating the message digest with the document stored in the data storage area 121.

The user who wants to notify that availability of the document attaches the document itself to the email and sends or forwards the email. When the email addressed to the user belonging to the mail server and having the document as an attachment is received, the mail analyzing unit 212 calculates the message digest and sends the message digest and the address data to one or plurality of management servers set beforehand as destination servers.

Upon receiving the message digest, etc. from the mail server 200, the access-authorization setting unit 114 of the management server 100 looks for the message digest received from the mail server 200 in the access-authorization control table 122. If an entry having the message digest is found, and no constraints are set in the entry, the access-authorization setting unit 114 sets access authorization to the document so that the user corresponding to the email address received from the mail server 200 can access the document associated with the entry.

This method is useful for users who are not familiar with URL as the document itself is attached to the sent or forwarded email. However, as the versions of the document are managed by the management server 100, it is important that the management server 100 appropriately sets the access authorization to the latest version of the document.

As a variation of the method described above, the registering unit 112 of the management server 100, upon being requested to register a document, can create a distribution copy of the document meant for distribution, calculate the message digest for the distribution copy, and store in the access-authorization control table 122 the message digest, associating the message digest with the document stored in the data storage area 121.

To notify the availability of the document to interested users, a user can attach the distribution copy to the email. The distribution copy created by the registering unit 112 is smaller in size than the original document. Consequently, the load on the mail server 200 and the network can be reduced by attaching the distribution copy than the original document.

When creating a distribution copy, several different methods or a combination thereof can be employed. For example, a method of creating the distribution copy can be employed in which only the first page of the original document is extracted to create the distribution copy. Alternatively, the distribution copy can be created without drawings that may be there in the original document, or in a format that allows the file size to be reduced. Further, a method may be employed to create the distribution copy that allows the original document to be compressed.

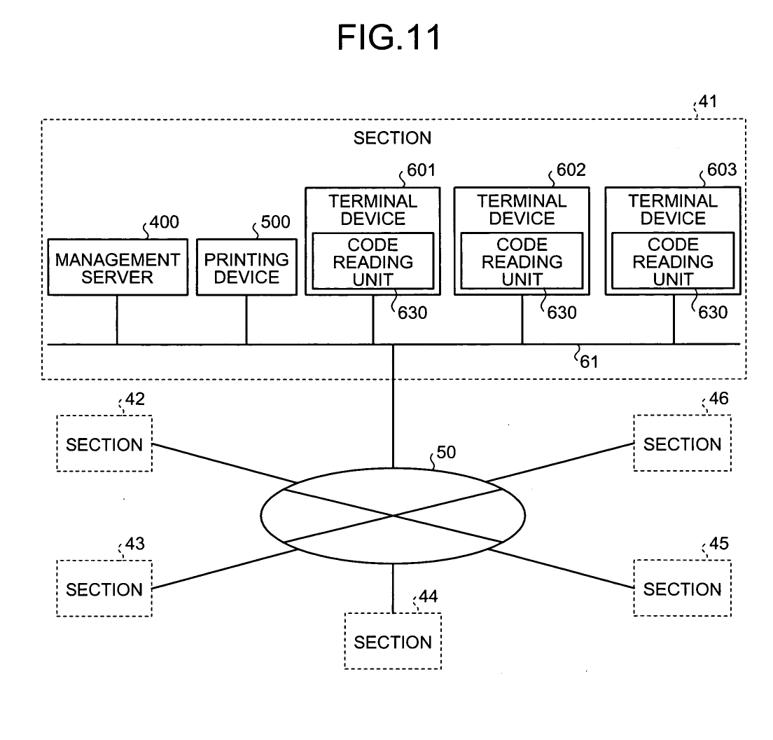

Instead of by email, the availability of a document can be notified by a printed document. In a second embodiment of the present invention, a method of automatic access authorization setting upon notification by a printed document is described. FIG. 11 is a schematic of an example of an environment to which an access authorization setting method according to a second embodiment of the present invention is applied.

Shown in FIG. 11 is an intranet that includes a network 50 that connects sections 41 to 46. The section 41 includes a management server 400, a printing device 500, and terminal devices 601 to 604 used by users to create or view documents, all of which are connected to a LAN 61. Each of the terminal devices 601 to 603 includes a code reading unit 630 that reads a code printed in the document. The sections 42 to 46 also have the same structure as the section 41.

The management server 400 has the capacity to store large volumes of documents. Apart from the terminal devices 601 to 604 in the section 41, the documents stored on the management server 400 can also be accessed by the terminal devices in the sections 42 to 46. However, the management server 400 is configured to manage documents properly by setting access authorization to every document by specifying users that can access the document. In other words, the users for whom authorization for accessing a given document is not set cannot access the document.

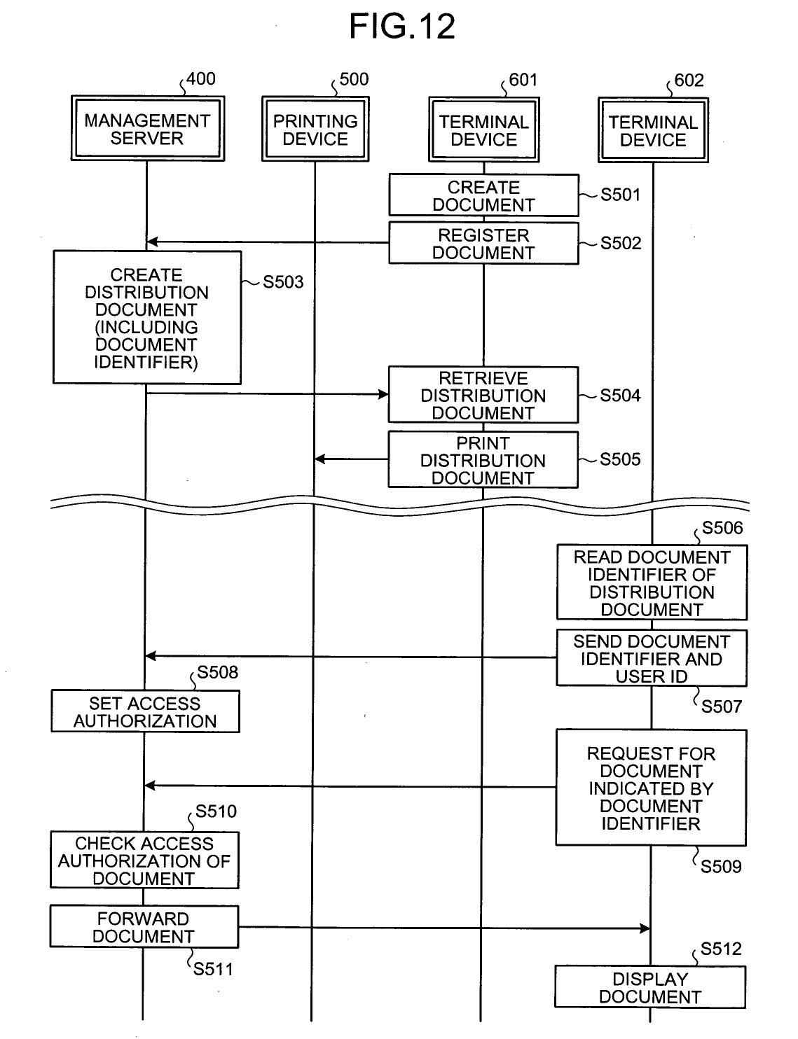

FIG. 12 is a schematic for explaining an overview of the access authorization setting method. The document supposed in the description is a document created by the user of the terminal device 601.

Once the user of the terminal device 601 has created the document (step S501), the user stores the document on the management server 400 to share the document with other users (step S502). While storing the document on the management server 400, the user sets access authorization to the document so that only the user himself/herself can access it, thus disabling accidental unauthorized access.

Once the document is stored, the management server 400 creates a distribution document based on the document (step S503). The distribution document includes a document identifier in an encoded form. The document identifier is a character string of a predetermined format indicating the location of the document on the management server 400 and is encoded in a printable form such as a one-dimensional bar code, or a two-dimensional Quick Response (QR) code and is embedded in the document.

The user of the terminal device 601 retrieves the distribution document (step S504) and prints it by outputting the distribution document to the printing device 500 (step S505). The printed distribution document changes hands to reach interested users. Apart from direct distribution from the user of the terminal device 601, the distribution document can be circulated through a plurality of intermediaries.

It is supposed in this example that the user of the terminal device 602 has received the distribution document. Upon receiving the distribution document, the user of the terminal device 602 lets the code reading unit 630 of the terminal device 602 read the encoded document identifier (step S506). Once the document identifier is read, the terminal device 602, sends the document identifier and the user ID of the user who has logged into the terminal device 602 to the management server 400, requesting the management server 400 to set access authorization to the document indicated by the document identifier (step S507).

Upon receiving the request, the management server 400 identifies the document corresponding to the received document identifier and set access authorization so that the user corresponding to the received user ID can access the document (step S508). In the present example, the management server 400 sets access authorization to the document so that the user of the terminal device 602 can access the document.

The terminal device 602 then requests the management server 400 to forward the document indicated by the document identifier (step S509). Upon receiving the request, the management server 400 looks for the access authorization of the requested document (step S510). In this case, as access authorization of the user of the terminal device is already set, the management server 400 forwards the document to the terminal device 602 (step S511). The document is displayed on a display device of the terminal device 602 (step S512).

Thus, in the access authorization setting method according to the second embodiment, access authorization is automatically set allowing the user who receives the distribution document to access the document stored on the management server by letting the document identifier printed in the distribution document to be read by the code reading unit 630 provided in the terminal device 602. The distribution document is circulated among all the interested users by the discretion of the users in the distribution channel. Thus, access authorization to access any document is automatically set for interested users the document creator may not even be aware of.

To prevent access authorizations from being set in an uncontrolled manner, the access authorization setting method according to the first embodiment has a control imposed on setting access authorizations based on the time that has elapsed since a document is stored on the management server 400.

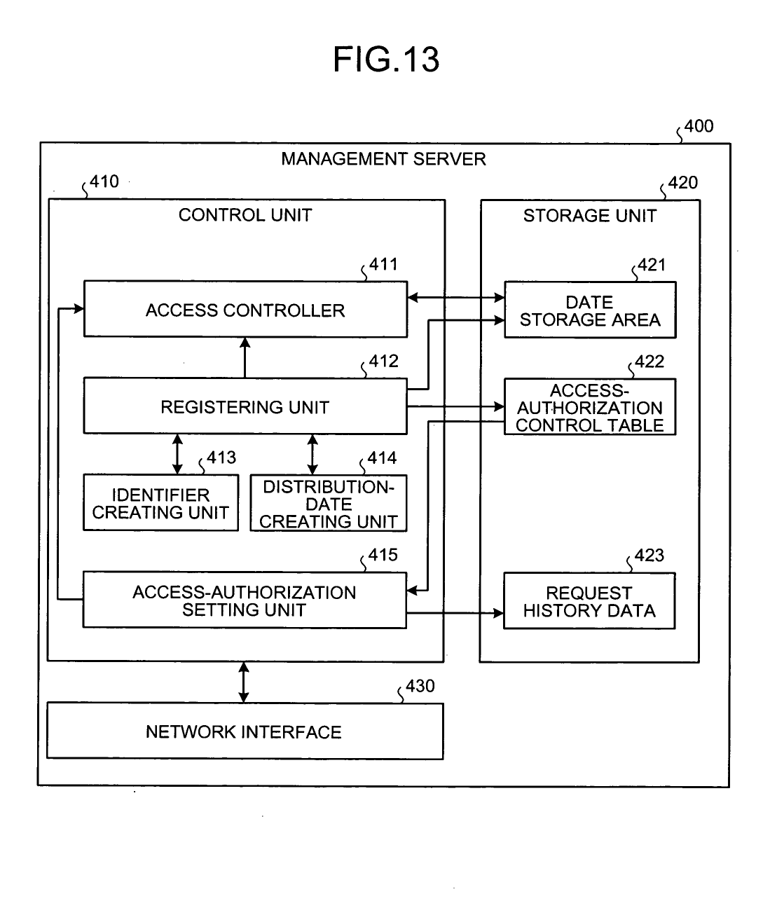

FIG. 13 is a functional block diagram of the management server 400. The management server 400 includes a control unit 410, a storage unit 420, and a network interface 430. The network interface 430 functions as an interface by which the management server 400 sends and receives data over a network.

The control unit 410 controls the entire management server 400 and includes an access controller 411, a registering unit 412, an identifier creating unit 413, a distribution-data creating unit 414, and an access-authorization setting unit 415. The access controller 411 sets access authorization to all the documents stored in a data storage area 421 of the storage unit 420, and performs various control actions so that only users having access authorization can access any document.

The registering unit 412 stores the document in the data storage area 421 according to the specification from the user, and requests the access controller 411 to set the specified access authorization to the document. When storing the document in the data storage area 421, the registering unit 412 sets, according to the specification from the user, information pertaining to the control of automatic setting of the access authorization in an access-authorization control table 422 of the storage unit 420.

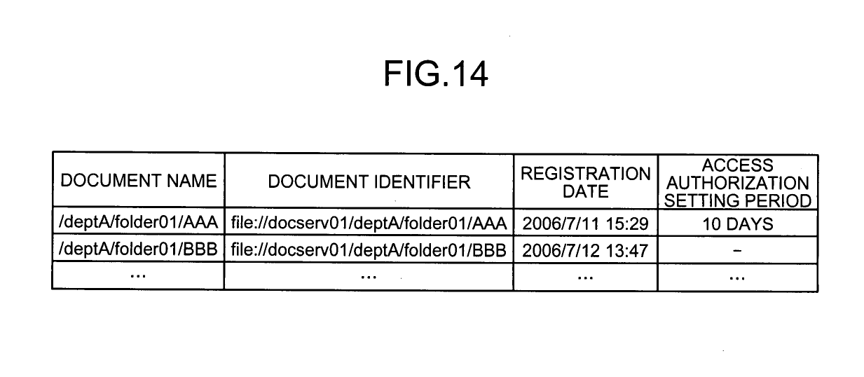

FIG. 14 is an example of contents of the access-authorization control table 422. The access-authorization control table 422 includes the fields Document name, Document identifier, Registration date, and Access-authorization setting period, and contains entries for all the documents stored in the data storage area 421.

The Document name field contains path names by which the management server 400 internally identifies the documents stored in the data storage area 421. The Document identifier field contains character strings of a predetermined format that indicate the storage location of the document from the perspective of the management server 400 and other devices connected to the network. In the example shown in FIG. 14, the storage locations of the documents are shown as character strings indicating URLs. The Registration date field contains the dates on which the documents are stored.

The Access-authorization setting period field specifies the period from the registration date for which automatic access authorization setting is enabled and is set to any value by the document creator. This field is provided taking into account the tendency that the email containing the document identifier is sent to interested users only within a specific period, beyond which there is a likelihood of the email being forwarded indiscriminately. Thus, by setting an appropriate period in Access-authorization setting period field, the access authorization to the document can be limited only to interested users. When no temporal constraint for automatic setting of access authorization is required, the Access-authorization setting period field is left blank.

The registering unit 412 lets the distribution-data creating unit 414 to create a distribution document of the document when storing the document in the data storage area 421.

The identifier creating unit 413 creates, according to a request from the registering unit 412, a document identifier for the document stored in the data storage area 421 by the registering unit 412.

The distribution document at least includes the document identifier created by the identifier creating unit 413 and encoded by a two-dimensional code, etc. The distribution document contains the document stored in the data storage area 421 but with a portion of the original document concealed. For example, the distribution-document may be created by extracting only the first page of the document, or by creating a synopsis of the document, or by excluding drawings and graphs, or by masking the proper nouns, or by a combination thereof. Thus, the distribution document, which is a clipped version of the original document, provides sufficient information for the user to make a judgment about who might be interested in the document without giving away the details of the document.

The access-authorization setting unit 415 sets access authorization to the document stored in the data storage area 421 based on the request received from the terminal device 601. Upon receiving a request from the terminal device 601, the access-authorization setting unit 415 looks up and retrieves from the access-authorization control table 422 the entry having the document identifier included in the request.

If no entry having the document identifier included in the request is found in the access-authorization control table 422, the access-authorization setting unit 415 ends the process without setting the access authorization.

If an entry is found in the access-authorization control table 422 that has the document identifier included in the request, the access-authorization setting unit 415 checks whether any value is set in the Access-authorization setting period field, and if so, calculates the time limit for automatic access authorization setting by adding the value to the registration date in the entry. If the current date is beyond the calculated time limit, the access-authorization setting unit 415 ends the process without setting the access authorization.

If the current date is within the calculated time limit, the access-authorization setting unit 415 lets the access controller 411 set access authorization to the document corresponding to the document identifier in the received information so that the user having the user ID included in the received information can access the document.

The storage unit 420 stores therein various types of data and includes the data storage area 421, the access-authorization control table 422, and a request history data 423. The request history data 423 has recorded therein, in the form of history, the document identifiers and user IDs included in the access request sent from the terminal device 601.

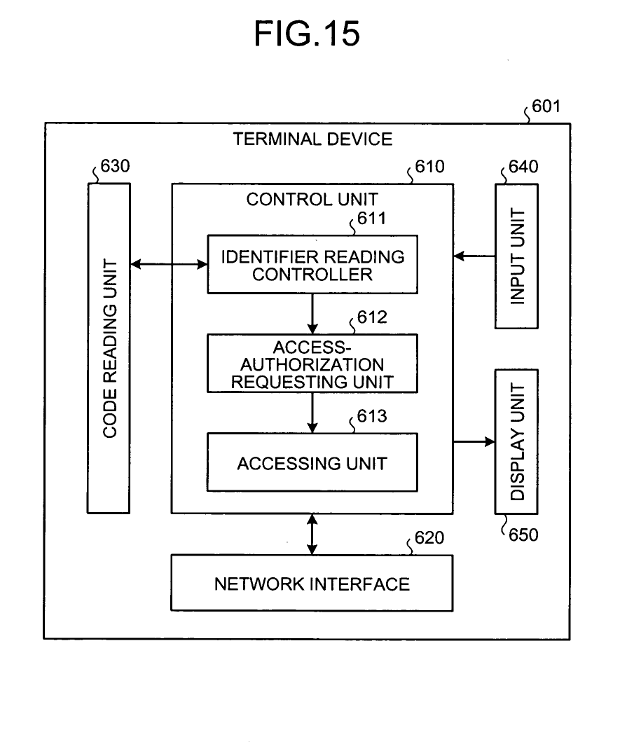

FIG. 15 is a functional block diagram of the terminal device 601. The terminal device 601 includes a control unit 610, a network interface 620, the code reading unit 630, an input unit 640, and a display unit 650. Incidentally, the terminal devices 602 and 603 have the same structure as that of the terminal device 601.

The network interface 620 functions as an interface by which the terminal device 601 sends and receives various data over the network. The code reading unit 630 reads and decodes the document identifier encoded by the distribution-data creating unit 414. The input unit 640 is an input device such as a keyboard. The display unit is a display device such as a liquid crystal panel.

The control unit 610 controls the entire terminal device 601i and includes an identifier reading controller 611, an access-authorization requesting unit 612, and an accessing unit 613. The identifier reading controller 611 controls the way the code reading unit 630 reads the document identifier.

The access-authorization requesting unit 612 identifies the management server in which the document is stored based on the document identifier read by the control action performed by the identifier reading controller 611, and requests the identified management server to set access authorization. The request sent by the access-authorization requesting unit 612 includes the document identifier read by the control action performed by the identifier reading controller 611 and the user ID of the user logged into the terminal device 601.

The accessing unit 613 requests the management server in which the document is stored to forward the document corresponding to the document identifier read by the control action performed by the identifier reading controller 611, and displays the document forwarded by the management server on the display unit 650.

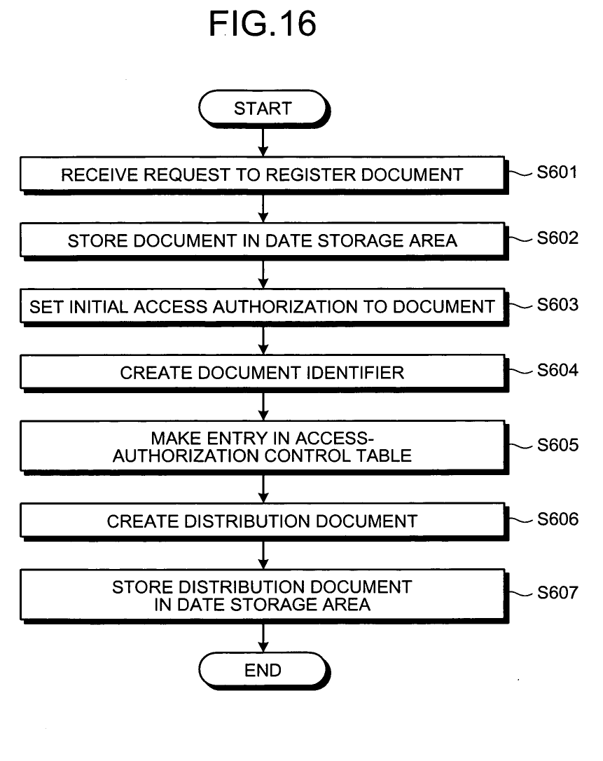

FIG. 16 is a flowchart of the operation of the management server 400 for document registration.

When the registering unit 412 receives a request from a document creator via the terminal devices 601 to 603 to register a document (step S601), the access controller 411 stores the document in the data storage area (step S602) and set the specified initial access authorization (step S603).

The identifier creating unit 413 creates a document identifier that indicates the location where the document is stored (step S604), makes a new entry in the access-authorization control table 422 by setting the document identifier and the constraints (step S605). The distribution-data creating unit 414 creates a distribution document of the document (step S606). The access controller 411 stores the distribution document in the data storage area 421 (step S607).

After the document is stored, the document creator prints the distribution document and distributes the distribution document to interested users, who in turn can circulate the distribution document among other users who they consider might be interested, and so on. The user who has received the distribution document reads the document identifier from his/her own terminal device to access the document. The process procedure of accessing the document is described below taking the terminal device 601 as an example.

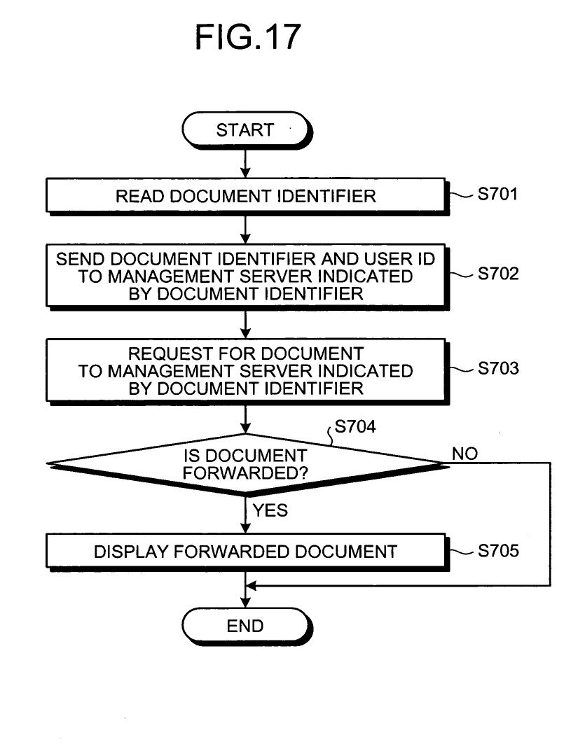

FIG. 17 is a flowchart of the operation of the terminal device 601 to access document data. When the document identifier is read by the control action of the identifier reading controller 611 (step S701), the access-authorization requesting unit 612 identifies the management server in which the document is stored based on the document identifier, and sends the document identifier and the user ID to the identified management server, requesting the management server to set access authorization (step S702).

The access-authorization requesting unit 612 then requests the management server to forward the document corresponding to the document identifier (step S703). Once the management server forwards the document (Yes at step S704), the display unit 650 displays the document (step S705).

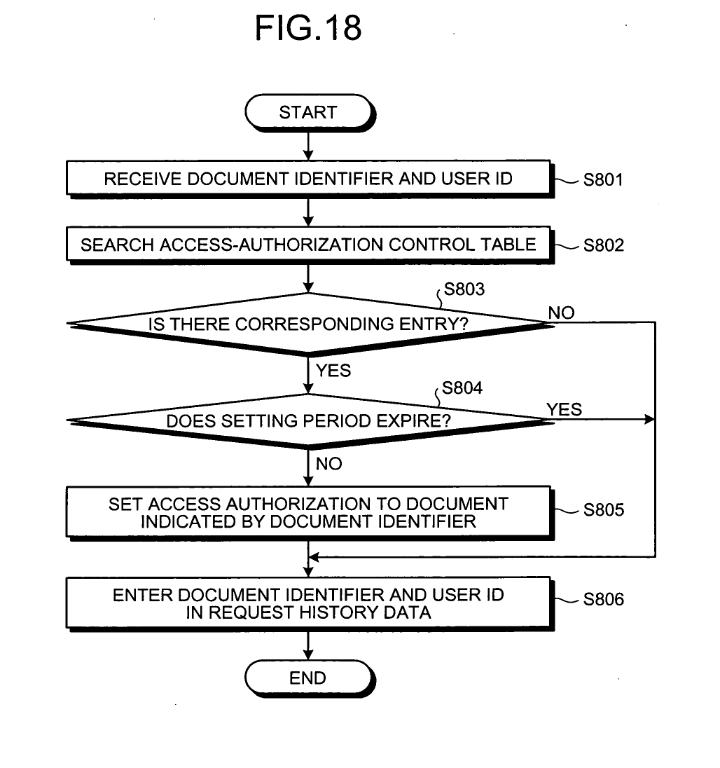

FIG. 18 is a flowchart of the operation of the management server 400 for access-authorization setting.

Upon receiving the document identifier and the user ID from the terminal device 601 (step S801), the access-authorization setting unit 415 retrieves the document identifier from the access-authorization control table 422 (step S802).

If no entry having the document identifier is found (No at step S803), the access-authorization setting unit 415 enters the received document identifier and the user ID in the request history data 423 and ends the process.

If an entry having the document identifier is found (Yes at step S803), and if a value is set in the Access authorization period field of the entry, the access-authorization setting unit 415 adds the value to the value in the Registration data field to calculate the time limit for automatic setting of access authorization. If the current date is beyond the calculated time limit (Yes at step S804), the access-authorization setting unit 415 enters the document identifier and the user ID in the request history data 423 and ends the process (step S806).

If no value is set in the Access authorization period or if the current date is within the calculated time limit (No at step S804), the access-authorization setting unit 415 lets the access controller 411 set access authorization to the document corresponding to the received document identifier so that the user having the received user ID can access the document (step S805), and enters the document identifier and the user ID in the request history data 423, ending the process (step S806).

The configuration of the management server 400 is susceptible to various modifications and alternative forms without departing from the scope of the present invention. For example, the control unit 410 is explained above as hardware; however, it can be implemented as software. In other words, a computer program can be executed on a computer, such as the computer 1000, to realize the same function as the control unit 410.

Similarly, the configuration of the terminal device 601 is susceptible to various modifications and alternative forms without departing from the scope of the present invention. For example, the control unit 610 is explained above as hardware; however, it can be implemented as software. In other words, a computer program can be executed on a computer, such as the computer 1000, to realize the same function as the control unit 610.

Thus, in the second embodiment, access authorization is automatically set when the terminal device reads the document identifier printed on the distribution document created for notifying the existence of a document so that the user of the terminal device can access the data. As a result, by distributing the distribution document to interested users and allowing the document identifier printed on the distribution document to be read by the terminal devices of the users, access authorization for accessing the document can be automatically set, making the document accessible to all the interested users.

In the second embodiment, the document identifier in the form of a two-dimensional code is embedded in the distribution document. A radio frequency identification (RFID) containing the document identifier can be affixed to the distribution document and the management server can be requested for access authorization after the terminal device reads the document identifier from the RFID.

The above embodiments are described on the assumption that data managed and accessed is document data; however, document data is cited merely by way of example and without limitation. Data can be tables, images, computer programs, files for programs, directories, and the like.

As set forth hereinabove, according to the embodiments of the present invention, when a mail server receives email containing an identifier, access authorization is automatically set to the document specified by the identifier so that the receiver of the email can access the document stored on a management server. When the mail server receives email containing a document as an attachment, access authorization is automatically set to the document so that the receiver of the email can access the document stored on the management server. Consequently, in the process of sequentially forwarding email to notify the availability of the document to interested users, access authorization can be set automatically for those users to allow them to access the document. In other words, if the document on the management server is updated, the access authorization to the updated document is sustained. Thus, the interested users can access the latest document at any given time.

Moreover, temporal constraint is imposed on automatic setting of access authorization. Because important documents are generally distributed to relevant users in a short period of time, and takes a relatively long time to arrive at irrelevant users. Thus, access right is prevented from being set to such irrelevant users due to due to sequential transfer of email.

Furthermore, access authorization is automatically set when email is sent from a registered user. Consequently, it is ensured that access authorization is automatically set only if the email is received from a legitimate source.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program for implementing a data management system that includes a management server to set access right to each data stored thereon to restrict, access to the data and an information server to deliver information, the computer program causing a computer to execute:
the information server receiving and analyzing information to check whether the information contains an identifier that indicates a location of data stored on the management server;
the information server extracting the identifier from the information;
the information server sending the identifier, an information source address and an information destination address to the management server specified by the identifier as a request to set access right to the data;
the management server referring to a conversion table to convert the information source address and the information destination address to identification information for access control thereto; and
the management server setting access right to the data specified by the identifier to allow a user with the identification information to access the data.

2. The computer-readable recording medium according to claim 1, wherein the management server setting includes setting access right to the data when the request is received before a time period preset for the data has elapsed.

3. The computer-readable recording medium according to claim 1, wherein the management server setting includes setting access right to the data when the information source address matches an information source address associated with the data previously stored thereon.

4. The computer-readable recording medium according to claim 1, wherein the management server setting includes setting access right to the data when number of times the information corresponding to the request has been forwarded exceeds a threshold associated with the data previously stored thereon.

5. The computer-readable recording medium according to claim 1, wherein the identifier is a uniform resource locator identifier.

6. The computer-readable recording medium according to claim 1, wherein the identifier is a universal naming convention identifier.

7. A computer-readable recording medium that stores therein a computer program for implementing a data management system that includes a management server to set access right to each data stored thereon to restrict access to the data and a terminal device that accesses the data stored on the management server via a network, the computer program causing a computer to execute:
the terminal device receiving distributed data and reading from the distributed data an identifier that indicates a location of data stored on the management server;
the terminal device sending the identifier and identification information of a user thereof to the management server specified by the identifier as a request to set access right to the data; and
the management server setting access right to the data specified by the identifier to allow the user with the identification information to access the data.

8. A computer-readable recording medium that stores therein a computer program for implementing a data management system that includes a management server to set access right to each data stored thereon to restrict access to the data and an information server to deliver information, the computer program causing a computer to execute:
the information server receiving and analyzing information-to check whether the information is accompanied by data;
the information server computing a message digest for the data;
the information server sending the message digest, an information source address and an information destination address to at least one predetermined management server as a request to set access right to the data;
the management server computing a-message digest for data to store the data in association with the message digest;
the management server referring to, upon receiving the request, a conversion table to convert the information source address and the information destination address to identification information for access control thereto; and
the management server setting access right to data associated with a message digest that matches the message digest from the information server to allow a user with the identification information to access the data.

9. The computer-readable recording medium according to claim 8, wherein the management server computing includes creating to-be-distributed data from the data, and computing a message digest for the to-be-distributed data, instead of the data, to store the data in association with the message digest.

10. A data management system comprising:
a management server that sets access right to each data stored thereon to restrict access to the data; and
an information server that delivers information, wherein
the information server includes an analyzing unit that receives and analyzes information to check whether the information contains an identifier that indicates a location of data stored on the management server, and, when an identifier exists, extracts the identifier from the information; and
a requesting unit that sends the identifier, an information source address and an information destination address to the management server specified by the identifier as a request to set access right to the data, and
the management server includes
a converting unit that refers to a conversion table to convert the information source address and the information destination address to identification information for access control on the management server; and
an access-right setting unit that sets access right to the data specified by the identifier to allow a user with the identification information to access the data.

11. A data management system comprising:
a management server that sets access right to each data stored thereon to restrict access to the data; and
a terminal device that accesses the data stored on the management server, wherein
the terminal device includes
an identifier reading unit that receives distributed data and reads from the distributed data an identifier that indicates a location of data stored on the management server; and
a requesting unit that sends the identifier and identification information of a user of the terminal device to the management server specified by the identifier as a request to set access right to the data, and
the management server includes an access-right setting unit that sets access right to the data specified by the identifier to allow a user with the identification information to access the data.

12. A data management system comprising:
a management server that sets access right to each data stored thereon to restrict access to the data; and
an information server that delivers information, wherein
the information server includes:
an analyzing unit that receives and analyzes information to check whether the information is accompanied by data, and, when data exists, computes a message digest for the data; and
a requesting unit that sends the message digest, an information source address and an information destination address to at least one predetermined management server as a request to set access right to the data, and
the management server includes:
a storing unit that computes a message digest for data to store the data in the management server in association with the message digest;
a converting unit that refers to, upon receiving the request, a conversion table to convert the information source address and the information destination address to identification information for access control on the management server; and
an access-right setting unit that sets access right to data associated with a message digest that matches the message digest from the information server to allow a user with the identification information to access the data.

13. An access-right setting method that is applied to a data management system that includes a management server to set access right to each data stored thereon to restrict access to the data and an information server to deliver information, the access-right setting method comprising:
the information server receiving and analyzing information to check whether the information contains an identifier that indicates a location of data stored on the management server;
the information server extracting the identifier from the information;
the information server sending the identifier, an information source address and an information destination address to the management server specified by the identifier as a request to set access right to the data;
the management server referring to a conversion table to convert the information source address and the information destination address to identification information for access control thereto; and
the management server setting access right to the data specified by the identifier to allow a user with the identification information to access the data.

14. An access-right setting method that is applied to a data management system that includes a management server to set access right to each data stored thereon to restrict access to the data and a terminal device that accesses the data stored on the management server, the access-right setting method comprising:
the terminal device receiving distributed data and reading from the distributed data an identifier that indicates a location of data stored on the management server;
the terminal device sending the identifier and identification information of a user thereof to the management server specified by the identifier as a request to set access right to the data; and
the management server setting access right to the data specified by the identifier to allow the user with the identification information to access the data.

15. An access-right setting method that is applied to a data management system that includes a management server to set access right to each data stored thereon to restrict access to the data and an information server to deliver information, the access-right setting method comprising:
the management server computing a first message digest for data to store the data in association with the first message digest;
the information server receiving and analyzing information to check whether the information is accompanied by data;
the information server computing a second message digest for the data;
the information server sending the second message digest, an information source address and an information destination address to at least one predetermined management server as a request to set access right to the data;
the management server referring to, upon receiving the request, a conversion table to convert the information source address and the information destination address to identification information for access control thereto; and
the management server setting access right to the data associated with the first message digest that matches the second message digest to allow a user with the identification information to access the data.
